(19) United States
(12) Patent Application Publication
(10) Pub. No.: US 2003/0228047 A1
(43) Pub. Date: Dec. 11, 2003

(54) Photomask transparent substrate protection during removal of opaque photomask defects

(75) Inventors: Wei-Zen Chou, Taipei (TW); Chin-Wei Wen, Tainan (TW); Fei-Gwo Tsai, Hsin-Chu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/165,008

(22) Filed: Jun. 7, 2002

(51) Int. Cl. G06K 9/00

(52) U.S. Cl. 382/144

(57) ABSTRACT

Protecting the transparent substrate of a photomask when repairing opaque defects of the mask is disclosed. The photomask includes an opaque defect on a transparent substrate. The photomask is coated with photoresist. The mask is backside-exposed to a light source, to expose the photoresist where it is unblocked by the mask's opaque defect and other opaque regions. The photoresist is removed where it was unexposed to the light source. The opaque defect and the other opaque regions of the mask are exposed through the photoresist, but the transparent regions of the mask—where the transparent substrate does not have the opaque defect or the other opaque regions thereon—remain protected by the photoresist. The opaque defect is then removed, such as by using a focused ion beam (FIB). The photoresist over the exposed transparent substrate protects the substrate from riverbed effects and gallium staining.

### FIELD OF THE INVENTION

This invention relates generally to the fabrication of photomasks for use in semiconductor fabrication photolithography, and more specifically to the repair of such photomasks.

### BACKGROUND OF THE INVENTION

The accuracy of a photomask, also commonly referred to as a mask, is crucial for ensuring that the semiconductor devices formed are also accurate, and perform correctly. A photomask is generally a mask used in photolithography to block photoresist exposure in selected areas. A photomask generally includes chrome opaque areas that block light exposure, supported by a quartz plate that is transparent to light exposure. Opaque areas may also be a molybdenum silicide material, such as MoSiON, in lieu of chrome.

Defects in a photomask in particular can cause the semiconductor devices fabricated with the photomask to malfunction. Two common defects are shown in FIGS. 1A and 1B. In FIG. 1A, the mask 102 has a proper opaque region 104, but an improper opaque spot 106. Conversely, in FIG. 2B, the opaque region 110 of the mask 108 has an improper hole 112. Other common mask defects include inclusions of opacity into a clear region, protrusions of clarity into an opaque region, clear breaks within opaque regions, and opaque bridges between one opaque region and another opaque region.

Clear or missing parts of a mask are typically repaired by “patching” them with a carbon deposit. Opaque or unwanted chrome regions are usually removed by sputtering from a focused ion beam (FIB). One type of focused ion beam is a gallium ion beam. A focused gallium ion beam is capable of milling away opaque defects and depositing carbon film for clear defects at desired locations. The gallium ion beam may be used to help form the opaque regions on a clear mask, as well as to repair opaque and clear defects on the formed mask. The gallium ion beam is a positive ion beam, since gallium ions are themselves positive ions. Thus, FIB systems use a focused beam of gallium ions that can be operated at high beam currents for site-specific sputtering or milling.

Furthermore, since the invention of the integrated circuit (IC), semiconductor chip features have become exponentially smaller and the number of transistors per device exponentially larger. Advanced IC's with hundreds of millions of transistors at feature sizes of 0.13 micron, 0.10 micron, and less are becoming routine. Improvement in overlay tolerances in optical photolithography, and the introduction of new light sources with progressively shorter wavelengths, have allowed optical steppers to significantly reduce the resolution limit for semiconductor fabrication far beyond one micron.

The reduction in feature size makes for fabrication of photomasks a more difficult and expensive process. Mask repair is especially difficult at small feature sizes. This is the case with repairing opaque defects on a photomask. In particular, it is difficult to focus the FIB only on the opaque defect to be removed, without also affecting some of the quartz substrate surrounding the defect. The result is that undesirable grooves in the quartz substrate surrounding the defects can occur, which is known as “riverbed” effects. Furthermore, extraneous gallium ions may stay on the quartz substrate, affecting the transparency of the substrate, in an effect known as gallium staining.

FIG. 3 illustratively shows an example of the riverbed effect on a photomask 202. The photomask 202 has a transparent substrate 204, which is typically quartz, and properly fabricated opaque regions 206 thereover, which may be chrome, MoSiON, and so on. However, an undesirable opaque defect 208 has been deposited between the opaque regions 206 on the substrate 204. Therefore, an FIB 210 is directed towards the defect 208 to remove it, such as by milling. However, where the feature size of the photomask 202 is very fine, the resolution of the FIB 210 is not sufficiently fine to only remove the defect 208. As a result, grooves 212 and 214 occur in the substrate 204, which are undesirable. Gallium staining of the exposed substrate 204 may also result.

Therefore, there is a need for photomask repair that does not exhibit these problems. Specifically, there is a need for preventing riverbed and gallium staining effects when removing opaque mask defects. Such prevention should be achieved especially when employing an FIB to mill away or otherwise remove such opaque defects. For these and other reasons, there is a need for the present invention.

### SUMMARY OF THE INVENTION

The invention relates to protecting the transparent substrate of a photomask when repairing opaque defects of the mask. The photomask includes an opaque defect on a transparent substrate. The photomask is coated with photoresist, such as negative photoresist. The mask is backside-exposed to a light source, to expose the photoresist where it is not blocked by the opaque defect and other opaque regions of the photomask. The photoresist is preferably developed to remove the photoresist where it was unexposed to the light source. Thus, the opaque defect and the other opaque regions of the mask are exposed through the photoresist, but the transparent regions of the mask —where the transparent substrate does not have the opaque defect or the other opaque regions thereon—remain protected by the photoresist.

The opaque defect is then removed, such as by using a focused ion beam (FIB). The photoresist over the exposed transparent substrate protects the substrate from riverbed effects and gallium staining, which is the advantage of the invention. The photoresist that remains, which is the photoresist that was exposed to the light source from the mask's backside, is then removed, such as by photoresist stripping. The transparent substrate of the photomask may be quartz, whereas the opaque defect and the other opaque regions of the mask may be chrome, a molybdenum silicide material such as MoSiON, or another material. Still other aspects, embodiments, and advantages of the invention will become apparent by reading the detailed description that follows, and by referencing the attached drawings.

### BRIEF DESCRIPTION OF THE DRAWINGS

FIGS. 1A and 1B are diagrams showing an example opaque defect and an example clear defect, respectively, that can occur when fabricating photomasks.

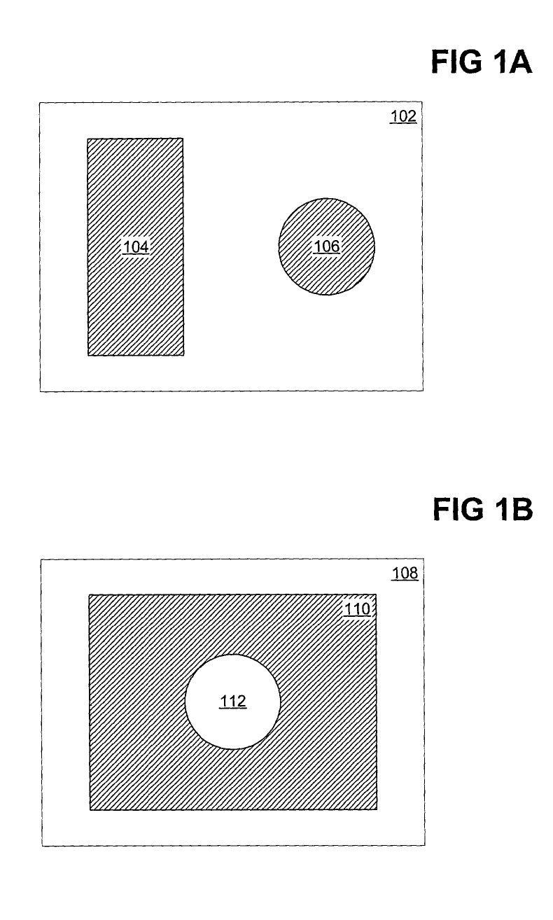

FIG. 2 is a diagram showing how removing an opaque defect on a photomask by using a focused ion beam (FIB) can also cause riverbed effects, in addition to gallium staining effects.

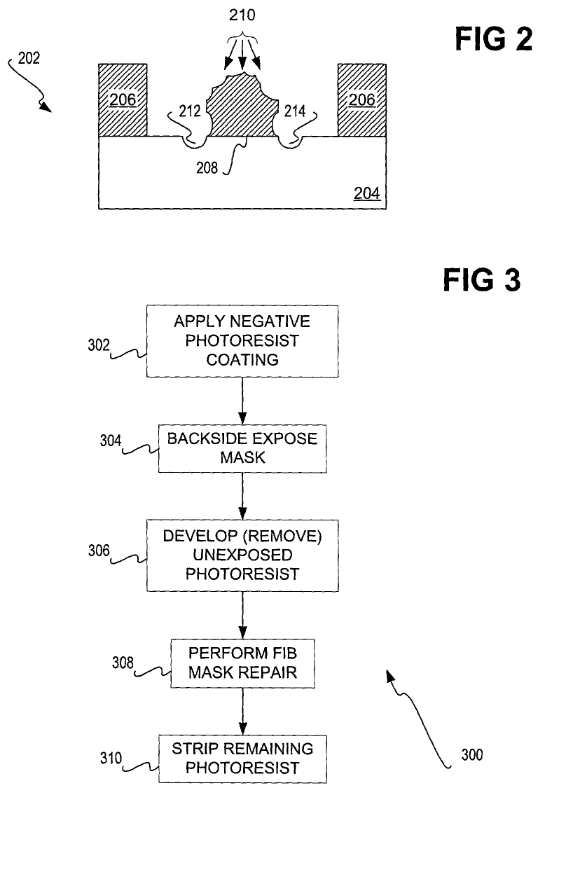

FIG. 3 is a flowchart of a method for removing an opaque defect on a photomask by using a FIB, but avoiding riverbed and gallium staining effects, according to an embodiment of the invention.

FIGS. 4A, 4B, 4C, 4D, and 4E are diagrams showing illustratively the performance of the parts of the method of FIG. 3, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

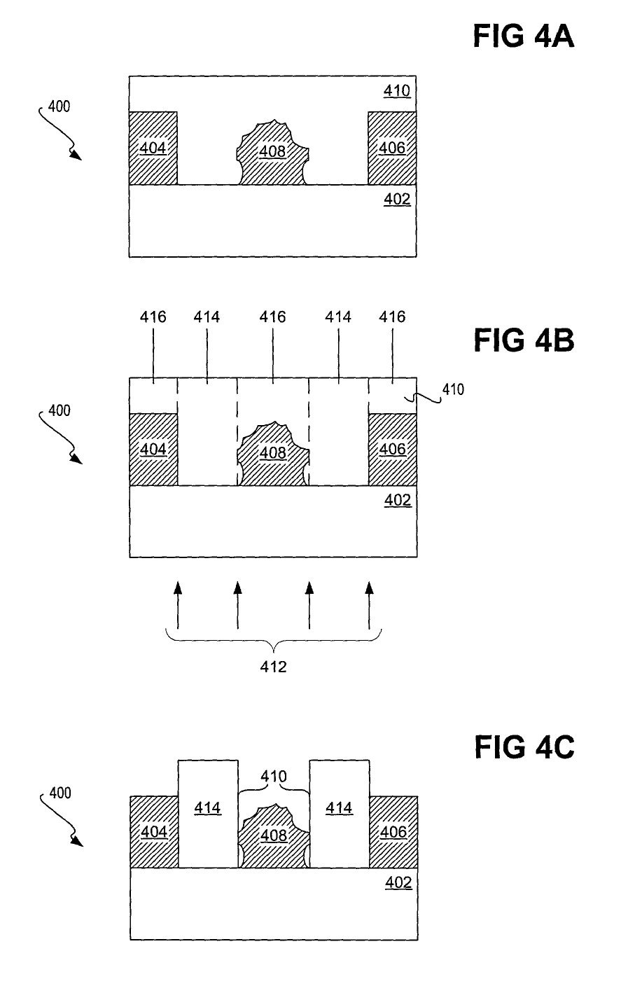

FIG. 3 shows a method 300 for repairing an opaque defect from a photomask, according to an embodiment of the invention. The method 300 may be used in part to fabricate a photomask as well, such as to repair the photomask after it has been manufactured. A semiconductor device may also be at least in part fabricated by using a photomask that is fabricated and/or repaired according to the method 300.

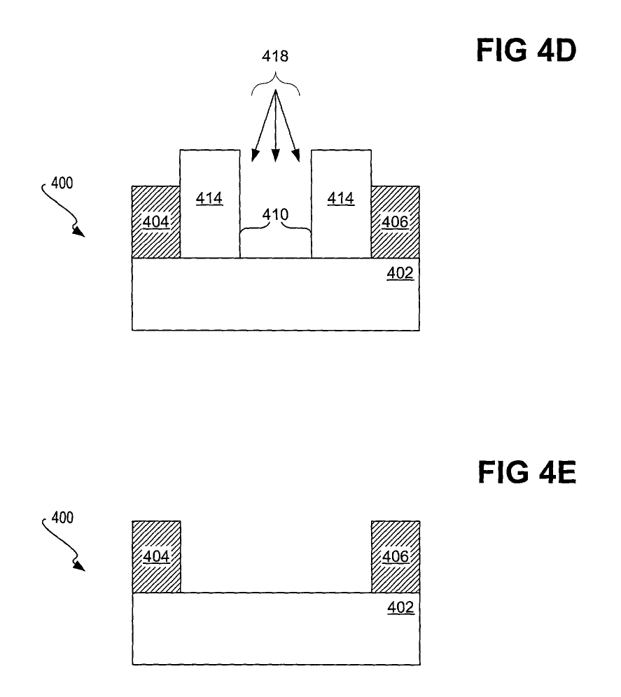

First, a preferably negative photoresist coating is applied 5 over a mask that has an opaque defect (302). This is illustratively shown in FIG. 4A. The photomask 400 includes a transparent substrate 402, which may be quartz. The photomask 400 also includes desired opaque regions 404 and 406 over the transparent substrate 402, and an undesired opaque defect 408. The parts of the transparent substrate 402, between either region 404 or 406 and the defect 408, that do not have a corresponding opaque region or defect thereover are the transparent regions of the mask 400.

Thus, the defect 408 is isolated, in that it is not immediately adjacent to, and does not touch, one of the desired opaque regions 404 and 406. The opaque regions 404 and 406 and the opaque defect 408 may be chrome, a molybdenum silicide material such as MoSiON, or another material. They are opaque in that they substantially block light from passing through, whereas the transparent regions are transparent in that they substantially allow light to pass through.

Negative photoresist 410 preferably coats the entirety of the photomask 400. The photoresist 410 is negative in that when it is partially exposed to a light source and subsequently developed, only the parts of the photoresist 410 that were not exposed to the light source are removed. This is in distinction with positive photoresist, which when developed only the exposed parts thereof are removed, as can be appreciated by those of ordinary skill within the art.

Referring back to FIG. 3, the photomask is backside exposed to a light source, preferably an ultraviolet (UV) light source (304). This is illustratively shown in FIG. 4B. From the backside, or bottom, of the photomask 400, a light source shines, as indicated by the arrows 412. All the light passes through the transparent substrate 402, since this region is transparent and lets light pass. However, the opaque regions 404 and 406 and the opaque defect 408 do not let light pass. Therefore, only the parts 414 of the photoresist 410 are exposed to the light source, since these parts do not have an opaque region or an opaque defect underneath them. By comparison, the parts 416 of the photoresist 410 are not exposed to the light source.

Referring back to FIG. 3, the photoresist as has been partially exposed to a light source is developed, which removes the unexposed photoresist (306). As has been indicated, only the unexposed photoresist is removed, because the photoresist is negative photoresist preferably. This is illustratively shown in FIG. 4C. Only the parts 414 of the photoresist 410 that are not over the opaque regions 404 and 406 and the opaque defect 408 remain. That is, the parts 414 of the photoresist 410 were exposed to the backside-emitting light source, since they were not blocked by the opaque regions 404 and 406 and the opaque defect 408, and lie directly over the transparent substrate 402 of the mask 400. Thus, the parts of the transparent substrate 402 that are not covered with the opaque regions 404 and 406 and the opaque defect 408 are now protected/covered by the parts 414 of the photoresist 410. The opaque regions 404 and 406 and the opaque defect 408 are exposed, resulting from the removal of the parts 416 of the photoresist 410.

Referring back to FIG. 3, the opaque defect is removed, preferably by performing focused ion beam (FIB) mask repair (308). Such mask repair does not result in gallium staining or riverbed effects, because the photoresist remaining over the transparent substrate thereof protects the substrate from the FIB. This is illustratively shown in FIG. 4D. In the mask 400, the opaque defect 408 has been removed, resulting from milling away by the FIB, as represented by the arrows 418. Riverbedding and gallium staining that result in the prior art from such FIB application are prevented by the presence of the parts 414 of the photoresist 410 over the transparent substrate 402 that would otherwise be exposed to the FIB. The mask 400 still includes the desired opaque regions 404 and 406, since these are sufficiently far away from the FIB that they are preferably not affected by the FIB.

Referring finally back to FIG. 3, the remaining photoresist is removed, such as by stripping (310). This is the photoresist that was exposed by the backside light, and that was thus not blocked by the opaque regions or the opaque defect during this backside light exposure. Photoresist removal is illustratively shown in FIG. 4D. The mask 400 now includes the desired opaque regions 404 and 406 on top of the transparent substrate 402, without the presence of the opaque defect 408. The parts 414 of the photoresist 410 have also been removed. Thus, the mask 400 as shown in FIG. 4D is the end product after photomask repair. The mask 400 may now be used for semiconductor device fabrication, or may itself be further manufactured.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

We claim:

1. A method comprising:
coating a photomask including an opaque defect on a transparent substrate with photoresist;
backside-exposing the photomask with a light source to expose part of the photoresist;
removing another part of the photoresist unexposed to the light source; and,
removing the opaque defect on the transparent substrate of the photomask.

2. The method of claim 1, further comprising removing the part the photoresist exposed to the light source.

3. The method of claim 2, wherein removing the part of the photoresist exposed to the light source comprises stripping the part of the photoresist exposed to the light source.

4. The method of claim 1, wherein coating the photomask with the photoresist comprises coating the photomask with negative photoresist.

5. The method of claim 1, wherein backside-exposing the photomask with the light source comprises backside-exposing the photomask with an ultraviolet (UV) light source.

6. The method of claim 1, wherein removing the other part of the photoresist unexposed to the light source comprises developing the photoresist.

7. The method of claim 1, wherein removing the opaque defect on the transparent substrate of the photomask comprises using a focused ion beam (FIB) to remove the opaque defect.

8. The method of claim 1, wherein the opaque defect comprises one of chrome and MoSiON, and the transparent substrate comprises quartz.

9. A photomask repaired by performing a method comprising:
coating with photoresist a photomask including a transparent substrate on which an opaque defect is isolated, the photomask also including desired opaque parts;
backside-exposing the photomask with a light source to expose parts of the photoresist unblocked by the opaque defect and the desired opaque parts from a backside of the photomask;
removing other parts of the photoresist blocked by the opaque defect and the desired opaque parts from the backside of the photomask, such that the opaque defect and the desired opaque parts are exposed; and,
removing the opaque defect on the transparent substrate of the photomask using a focused ion beam (FIB), the parts of the photoresist unblocked by the opaque defect and the desired opaque parts from the backside of the photomask protecting the transparent substrate from riverbed effects and gallium staining.

10. The photomask of claim 9, the method further comprising removing the parts of the photoresist exposed to the light source.

11. The photomask of claim 10, wherein removing the parts of the photoresist exposed to the light source comprises stripping the parts of the photoresist exposed to the light source.

12. The photomask of claim 9, wherein coating with the photoresist the photomask comprises coating with negative photoresist the photomask.

13. The photomask of claim 9, wherein backside-exposing the photoresist with the light source comprises backside-exposing the photomask with an ultraviolet (UV) light source.

14. The photomask of claim 9, wherein removing the parts of the photoresist blocked by the opaque defect and the desired opaque parts from the backside of the photomask comprises developing the photoresist.

15. The photomask of claim 9, wherein the opaque defect and the desired opaque parts of the photomask comprise one of chrome and MoSiON, and the transparent substrate comprises quartz.

16. A semiconductor device fabricated at least in part by using a photomask repaired by performing a method comprising:
coating with negative photoresist a photomask including transparent regions, desired opaque regions, and undesired opaque regions;
backside-exposing the photomask with a light source to expose parts of the negative photoresist unblocked by the desired and the undesired opaque regions;
developing the negative photoresist to remove other parts of the negative photoresist blocked by the desired and the undesired opaque regions from the backside of the photomask to expose the desired and the undesired opaque regions;
removing the undesired opaque regions using a focused ion beam (FIB), the parts of the negative photoresist unblocked by the desired and the undesired opaque regions from the backside of the photomask protecting the transparent regions of the photomask from riverbed effects and gallium staining.

17. The device of claim 16, the method further comprising stripping the parts of the negative photoresist unblocked by the desired and the undesired opaque regions to remove the parts of the negative photoresist.

18. The device of claim 16, wherein backside-exposing the photomask with the light source comprises backside-exposing the photomask with an ultraviolet (UV) light source.

19. The device of claim 16, wherein the desired and the undesired opaque regions comprise one of chrome and MoSiON.

20. The device of claim 16, wherein the transparent regions comprise a quartz substrate on which the desired and the undesired opaque regions are situated.
